(19) United States
(12) Patent Application Publication
(10) Pub. No.: US 2012/0108100 A1
(43) Pub. Date: May 3, 2012

(54) CONTROL UNIT WITH VOLTAGE SOURCE FOR AN ELECTROMOTIVE FURNITURE-DRIVE DEVICE

(75) Inventors: Michael Hüppe, Gummersbach (DE); Michael Kritzler, Gummersbach (DE)

(73) Assignee: ILCON GMBH, Freudenberg (DE)

(21) Appl. No.: 13/245,103

(22) Filed: Sep. 26, 2011

(30) Foreign Application Priority Data
Sep. 24, 2010 (DE) 10 2010 046 379.5

(51) Int. Cl. H01R 13/58; H01R 24/00

(52) U.S. Cl. 439/474; 439/660

(57) ABSTRACT

The invention relates to a control unit with storage batteries for an electromotive furniture-drive device with at least one drive unit which can be coupled to a piece of furniture or a lifting device. The control unit comprises a first housing part, provided with electronic components, and a second housing part comprising the storage batteries. For the purposes of establishing an electrically conductive connection between the storage batteries and the electronic components, at least one plug-in connection is provided, wherein at least one plug is provided on a housing part, and this plug interacts with a complementary plug-in socket on the other housing part. The control unit is distinguished in that the plug is arranged such that it allows an electrically conductive contact to be established approximately perpendicularly to the longitudinal extent of the housing parts.

The invention relates to a control unit with a voltage source for an electromotive furniture-drive device with at least one drive unit which can be coupled to an adjustable component of a piece of furniture or a lifting device, wherein the control unit comprises a first housing part, provided with electrical and/or electronic components, and a second housing part, which is provided with a voltage source and can be attached in an electrically conductive fashion to the first housing part and removed therefrom, wherein, for the purposes of establishing an electrically conductive connection between the voltage source and the electrical/electronic components, in each case electrically conductive contacts are provided on the housing parts, it being possible for contact to be established with these contacts via at least one plug-in connection, wherein at least one plug is provided on a housing part, and this plug interacts with a complementary plug-in socket on the other housing part.

Such a control unit is known, for example, from DE 10 2008 056 982 A1. DE 10 2008 056 982 A1 relates to an electromotive furniture-drive device with a drive motor and with a drive unit, of which the drive member can be coupled to an adjustable component of a piece of furniture or a lifting device, wherein the furniture-drive device comprises a storage-battery-containing housing which, for power-supply purposes, can be attached in an electrically conductive fashion to the control unit and, for the purposes of charging the storage battery, can be removed from the control unit and connected to a charger. Such electromotive furniture-drive devices are used, for example, for mobile lifting devices in the hospital and care sectors, for example for hospital beds, care beds, patient lifters and the like. The control unit here, with operating elements possibly provided thereon, should be arranged in a fixed position on the piece of furniture or on the patient lifter, but a storage-battery part should be provided in a removable manner on the control unit, in order to avoid the situation where the piece of furniture has to be moved laboriously up to a charging point.

In particular if use is made of the control unit in the care and hospital sectors, there is a need for the individual components to be encapsulated in a water-tight manner. It has to be ensured that moisture cannot pass into the furniture-adjusting device, the storage-battery-containing housing or current-carrying contacts.

In order to ensure such water tightness, DE 10 2008 056 982 A1 proposes to provide on an end side of a first housing part, around the electrically conductive contacts, a collar which projects from the end surface of the housing part and forms a kind of plug, which penetrates into a correspondingly designed plug-in socket on the end surface of the second housing part which is to be connected. The projecting collar is provided with an externally encircling sealing ring, which seals the plug-in connection internally along the encircling wall of the plug-in socket. The two housing parts are arranged on a carrying rail, wherein, for the purposes of attaching the second housing part to the first housing part, in the first instance the electrically conductive connection between the housing parts is established, by virtue of the plug and plug-in socket being inserted one inside the other, and then the housing is latched on the carrying rail at the end remote from the plug-in connection. For this purpose, in the first instance it is necessary for the second housing part to be attached to the first housing part in a tilted position, and then the second housing part is displaced axially in the direction of the first housing part and pivoted for the purposes of being latched to the carrying rail.

This design has a number of disadvantages in respect of the water tightness of the arrangement. On the one hand, the sealing strip of the plug-in connection is subjected to inadmissible stressing, i.e. is exposed to transverse forces, by the pivoting connection and accompanying skewing of the second housing part; on the other hand, the plug-in connection is accessible through the joint which separates the first and the second housing parts, and this makes it possible, in principle, for moisture to pass between the housing parts. If the seal is subjected to permanent stressing in the manner described above, it is not possible to prevent moisture from advancing to the electrical contacts over the long term.

It is therefore an object of the invention to improve a control unit of the type described in the introduction in respect of the requirements which have to be met by the water-tight encapsulation.

The intention is also to improve the handling capability of the control unit.

The object is achieved by a control unit of the type mentioned above which is distinguished in that the plug is arranged such that it allows electrically conductive contact to be established approximately perpendicularly to the longitudinal extend of the housing parts.

This has, in particular, the advantage that, when the second housing part is being attached to the first housing part, the plug-in connection is kept more or less free of inadmissible transverse forces, and so any seals provided on the plug or on the plug-in socket are not subjected to inadmissible mechanical stressing.

This means that permanent water tightness is ensured even when the control unit is subjected to pronounced stressing by frequent removal and attachment of the second housing part.

In the case of an advantageous variant of the control unit according to the invention, it is provided that the plug is guided out of a housing part and, when the connection is being established, penetrates into a plug-in socket provided on the underside of the respectively other housing part, such that the plug-in connection is fully covered by the housing part. In the case of this expedient and advantageous variant of the control unit, the plug-in connection is arranged outside the separating joint between the housing parts, and so any moisture which passes between the housing parts cannot reach the plug-in connection. This ensures, in particular, that, even if a seal provided on the plug-in connection is not sealing correctly, it is not possible for any moisture to reach the electrical contacts.

The plug is expediently designed as a right-angle plug.

In the case of a particularly preferred variant of the control unit according to the invention, the plug is part of an end covering cap of a housing part. This gives rise, in particular, to the various functionalities of the components used being well integrated. This also has production-related advantages, for example the covering cap and the plug may be formed in one piece.

It is particularly advantageous if the covering cap is designed as a strain-relief device for at least a cable connection from the control unit to the drive unit.

At least one covering cap comprises at least one plug-in lead-through for the plug of a cable connection from the control unit to a drive motor. The cable connection here serves expediently both for supplying power to one or more drive motors and for activating these motors.

In the case of an advantageous embodiment of the invention, the covering cap is designed in two parts, wherein a first and a second cap part, in the installed position, secure at least one connecting cable between them with strain relief. It is particularly advantageous here if the strain relief device is designed such that the cable connection is kept within a defined bending radius, which is preferably no less than 90°. This is also ensured, in particular, in that the act of securing the connecting cable or the connection cables between two cap parts ensures a defined position of the connecting cables in the connection region.

It is advantageous, in particular, if the relevant covering cap is designed as the covering cap provided with the plug.

In the case of a particularly preferred and advantageous variant of the control unit according to the invention, it is provided that the housing parts are arranged on a carrying rail which, along with at least one housing part, forms a cable duct for at least one connecting cable. It is particularly preferred for the cable duct to be formed between the second housing part, with the voltage source, and the carrying rail, and so both the connections of the connecting cables and part of the connecting cables are fully concealed by the housing parts. This arrangement is very advantageous not least for hygiene regions. Cables are known to collect dirt and to be difficult to clean.

In the case of an advantageous variant of the control unit according to the invention, it is provided that the first and the second housing part can be locked to one another in a form-fitting manner in each case in the region of facing end sides. As means for locking the housing parts to one another, a pivotable locking lever may be provided, for example, on one housing part, it being possible for this lever to be displaced, for example, in a recess on the end side of the other housing part.

As an alternative, the first and the second housing part can be latched to one another via a snap-fit/latching connection.

It is advantageous if at least one covering cap forms part of a latching connection between the housing parts.

As already mentioned above, the plug is expediently formed in one piece on the first cap part.

In the case of an expedient variant of the control unit according to the invention, it is provided that the first housing part, on its underside, has at least one lead-through and/or plug-in socket and/or plug for a cable connection. Expediently the first housing part on its underside, which faces the carrying rail, is provided with a lead-through and/or plug-in socket for the plug of a cable connection. The connecting cable is thus not just fully concealed by the housing part; in addition, this avoids deflection of the connecting cable or cables, and so the connecting cables are free of bending stress.

An advantageous configuration of the invention will be explained hereinbelow with reference to two exemplary embodiments illustrated in the drawings, in which:

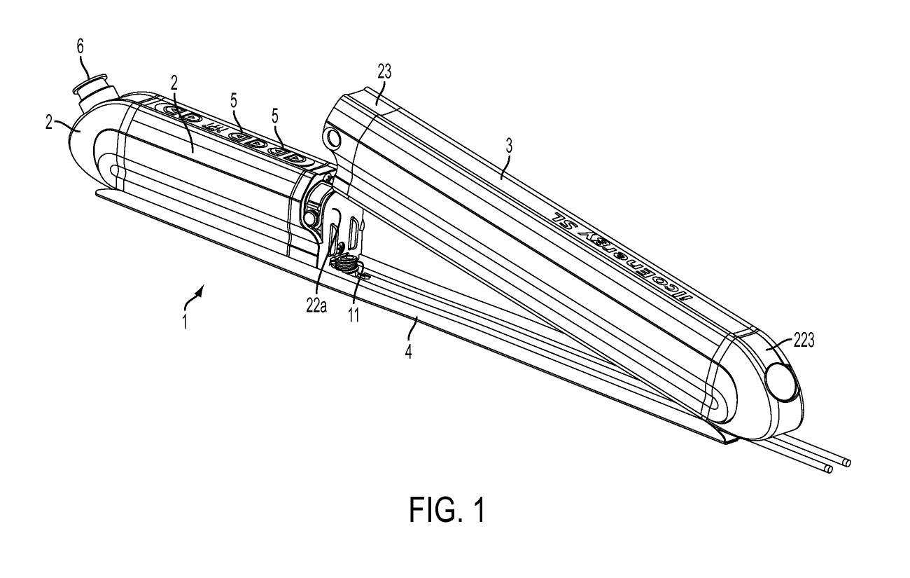

FIG. 1 shows a perspective illustration of the control unit according to a first exemplary embodiment of the invention with the second housing part not fully attached,

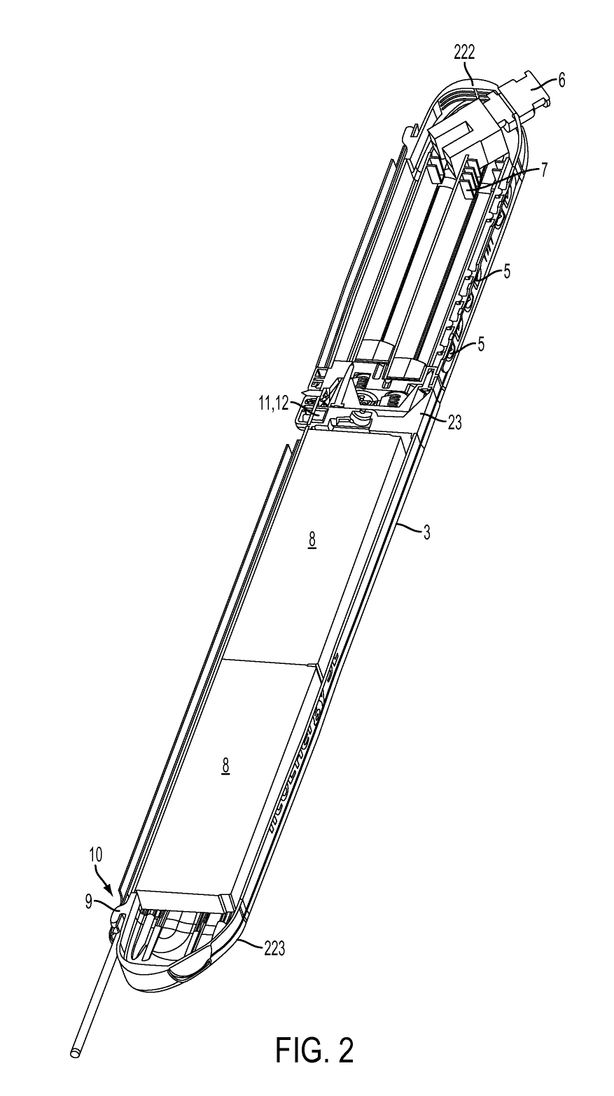

FIG. 2 shows a longitudinal section through the control unit in the assembled state,

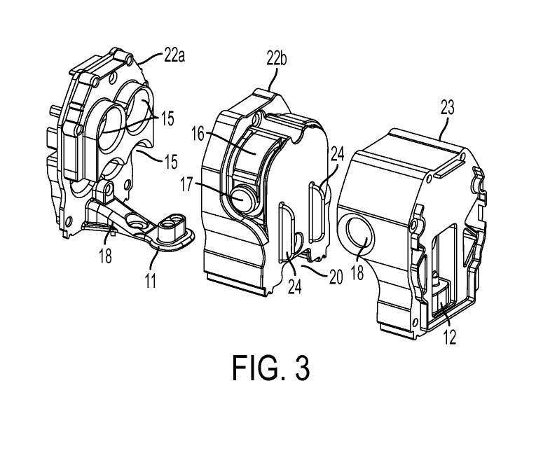

FIG. 3 shows an exploded view of the covering caps of the facing end sides of the housing parts,

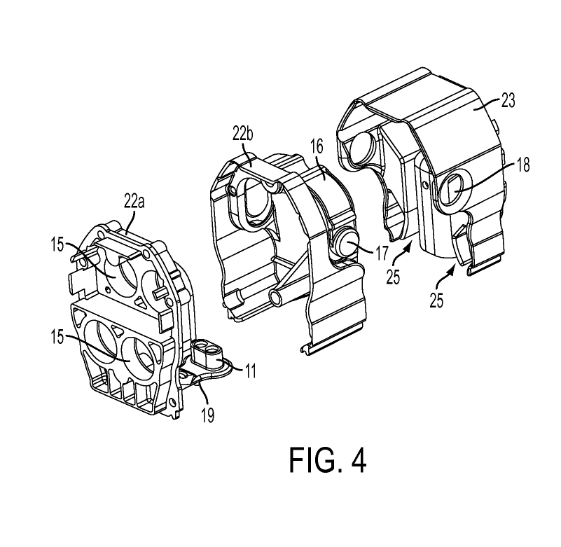

FIG. 4 shows a view corresponding to FIG. 3, but from a different direction,

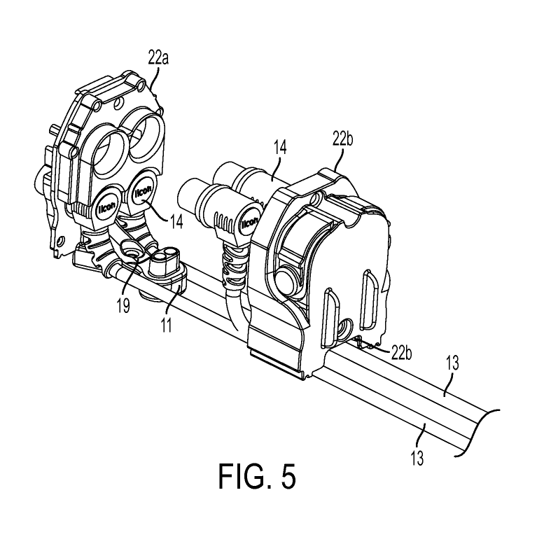

FIG. 5 shows an exploded view of a two-part covering cap with connecting cables arranged between the cap parts, and

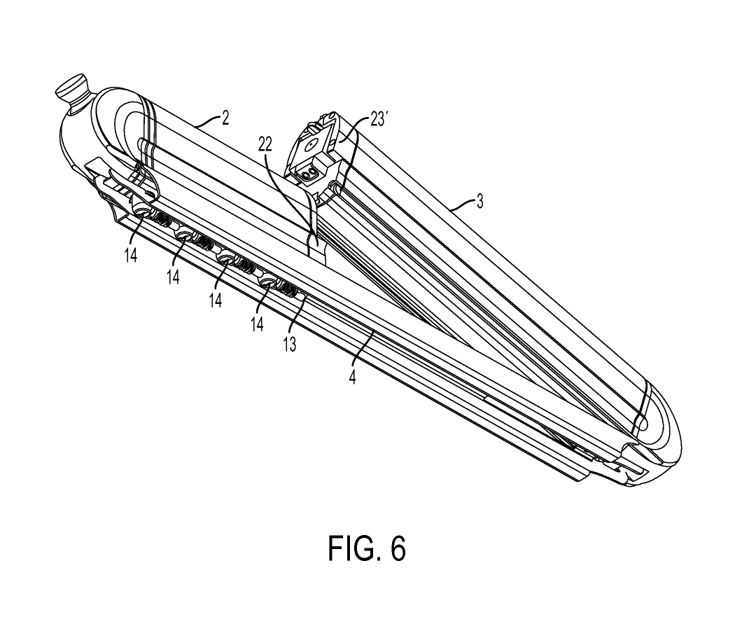

FIG. 6 shows a perspective illustration of the control unit according to a second exemplary embodiment of the invention,

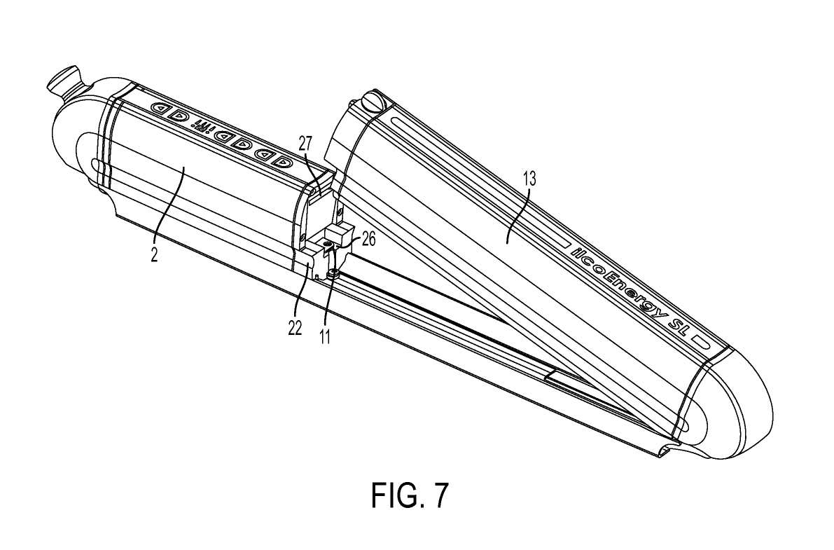

FIG. 7 shows a further perspective illustration of the control unit according to the second exemplary embodiment of the invention, and

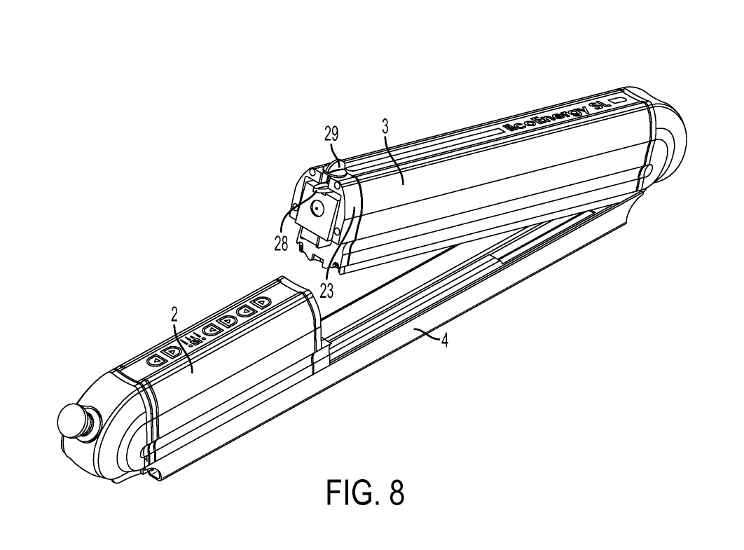

FIG. 8 shows a third perspective illustration of the control unit according to the second exemplary embodiment of the invention.

FIG. 1 shows the control unit 1 according to the invention approximately in its installed position on a vertical profile of a patient lifter (not illustrated).

The control unit comprises a first housing part 2, a second housing part 3 and a carrying rail 4, wherein the first housing part 2 is fastened at a fixed location on the carrying rail 4, which, in turn, is screwed, for example, to a vertical strut of a patient lifter.

Of course, the control unit may also be arranged on other furniture parts with electromotive adjusting devices.

The second housing part 3 can be attached in a releasable manner to the first housing part 2 and to the carrying rail 4.

The first housing part 2 comprises operating elements, for example in the form of known membrane switches 5 and an emergency stop button 6, which is at the top in the installed position. The first housing part 2 contains electronic components 7, which are only indicated in the illustration but each serve for controlling an electromotive drive device. The second housing part 3 comprises, in the present case, a plurality of storage batteries 8 which, for the sake of simplicity, will be referred to hereinbelow as batteries. The batteries 8 serve for supplying power both to the electronic components 7 and to the electromotive drive device (not illustrated).

The second housing part 3, as mentioned above, can be attached in a removable manner to the first housing part 2, to be precise such that the electronic components 7 can be brought into electronic contact with the batteries arranged in the second housing part 3.

Both the first and the second housing part 2, 3 are designed as extruded aluminum profiles, which are closed at each end by covering caps 22, 23, 222, 223, which will be described in more detail hereinbelow.

As can be gathered from looking at FIGS. 1 and 2 together, the second housing part 3 has a hook 9 formed on one side inserted in a window-like through-passage 10 in the carrying rail 4 such that the hook 9 engages behind the carrying rail 4. The second housing part 3 is then pivoted into the end position illustrated in FIG. 2 and latched to the first housing part 2, wherein, at the same time, electrical contact is established between the batteries 8 and the electronic components, as will be described in more detail hereinbelow.

For this purpose, a plug 11 designed as a right-angle plug is provided on the first housing part 2, and this plug interacts with a plug-in socket 12 on the underside of the second housing part 3. The right-angle plug 11 and the plug-in socket 12 are each provided on covering caps 22 and 23 of the first housing part 2 and of the second housing part 3.

22 and 23 designate the respectively facing covering caps in the region of the connection between the first housing part 2 and the second housing part 3, wherein the covering cap 22 is assigned to the first housing part and the covering cap 23 is assigned to the second housing part 3. The covering caps 22, 23 are formed from thermoplastic material. The covering caps 222, 223, which are remote in each case from the covering caps 22, 23, likewise consist of thermoplastic material.

Reference will be made hereinbelow to FIGS. 3 and 4, which illustrate exploded views of the covering caps 22 and 23. The covering cap 22 comprises a first cap part 22a and a second cap part 22b, which, in the assembled state, secure a total of four connecting cables 13 with plugs 14 between them. The connecting cables 13 serve for supplying power to, and for controlling, the electromotive drive devices which are to be activated by the control unit. The plugs 14 interact with plug-in sockets within the first housing part 2.

A total of four lead-throughs 15 for the plugs 14 are provided in the covering cap 22a of the first housing part. Electrical contact is established between the batteries 8 and the electronic components 7 via the plug 11, which is designed as a right-angle plug, and the plug-in socket 12, which accommodate, and guide, in each case electrically conductive contacts (not illustrated). The plug 11 is designed such that its plug-in contacts are guided out of the first housing part 2 transversely to the longitudinal extent of the housing parts 2, 3; the plug-in socket 12 is located on the underside of the second housing part, specifically on the underside of the covering cap 23, which closes the second housing part 3.

The first cap part 22a of the covering cap 22 is screwed with sealing action to the first housing part 2, i.e. with the interposition of a sealing strip or of some other sealing means. The second cap part 22b can be screwed, in turn, to the first cap part 22a, wherein the cap parts 22a and 22b secure the connecting cables 13 in a defined position between them, to be precise in a manner illustrated in FIG. 5, wherein the connecting cables 13 there are guided over the course of an arc of which the radius of curvature is comparatively large, and so the deflecting angle of the connecting cables 13, at any rate, is greater than or equal to 90°.

Two resilient tongues 16 are formed on the second cap part 22b, and the resilient tongues each have latching knobs 17 formed at their free ends, these knobs interacting with latching openings 18 on the covering cap 23. Once the plugs 14 have been introduced into the plug-in sockets provided for them, the cap parts 22a and 22b are screwed to one another. A fastening arm 19 of the plug 11 here passes through a through-passage 20 of the second cap part 22b, and so, with the second housing part 3 removed, the plug 11 is exposed. If the second housing part 3 is pivoted into its end position which is illustrated in FIG. 2, the plug 11 penetrates into the plug-in socket 12 provided on the underside of the covering cap 23. The plug 11 also comprises a sealing bellows 21, which can be seen only in FIG. 1 and seals the plug in the plug-in socket 12.

When electrical contact is established between the electronic components 7 and the batteries 8, a latching connection is produced at the same time between the covering caps 22 and 23 by the latching knobs 17 snap-fitting into the associated latching openings 18.

In order that skewing of the plug 11 and plug-in socket 12 is reliably prevented when the second housing part 3 is attached and inserted, guide logs 24 are provided on the second cap part 22b, these guide logs being guided in corresponding grooves 25 of the covering cap 23.

The covering cap 23 is screwed firmly, e.g. with sealing action to the second housing part 3.

As can be seen, in particular, from FIG. 1, the carrying rail 4 and the second housing part 3 form a cable duct for the connecting cables 13.

In the case of the second exemplary embodiment of the control unit 1 according to the invention, this embodiment being illustrated in FIGS. 6 to 8, both the first housing part 2 and the second housing part 3 are provided with a single-piece covering cap 22, 23. As can be gathered, in particular, from FIG. 7, the covering cap 22 is not provided with lead-throughs; rather, lead-throughs, which are not indicated specifically, but of which there is a total of four, each for accommodating the plugs 14 of the connecting cables 13, are provided on the underside of the first housing part 2, this underside facing the carrying rail 4. As with the first exemplary embodiment of the control unit 1 according to the invention, the connecting cables 13 are fully concealed by the first and second housing parts 2, 3. The plugs 14 are each designed as right-angle plugs and are connected to the first housing part 2 on that side of the latter which faces the carrying rail 4, and so the connecting cables 13 are not subjected to deflection or bending stress.

The covering cap 22 is formed in just one piece. The plug 11 is integrated in an offset formation 26 of the covering cap 22.

The covering cap 22, furthermore, is provided with a locking groove 27, which is open on the end side facing the covering cap 23. A pivoting locking catch 28 is integrated in the covering cap 23, and this catch can be pivoted by an actuating knob 29, about its axis of rotation, in and out of the end surface of the covering cap 23, and so, with the first and second housing parts 2, 3 in the assembled state, this catch penetrates, in the locked position, into the locking groove 27 of the covering cap 22.

### LIST OF DESIGNATIONS

1 Control unit
2 First housing part
3 Second housing part
4 Carrying rail
5 Membrane switch
6 Emergency stop button
7 Electronic components
8 (Storage) batteries
9 Hook
10 Through-passage
11 Plug
12 Plug-in socket
13 Connecting cable
14 Plug
15 Lead-throughs
16 Resilient tongues
17 Latching knobs
18 Latching openings
19 Fastening arm
20 Through-passage
21 Sealing bellows
22 Covering cap
22a First cap part
22b Second cap part
23 Covering cap
222, 223 Covering caps
24 Guide lugs
25 Grooves
26 Offset formation
27 Locking groove
28 Pivoting locking catch
29 Actuating knob

1. Control unit with a voltage source for an electromotive furniture-drive device with at least one drive unit which can be coupled to an adjustable component of a piece of furniture or a lifting device, wherein the control unit comprises a first housing part, comprising electrical and/or electronic components, and at least a second housing part, which is provided with a voltage source and can be attached in an electrically conductive fashion to the first housing part and removed therefrom, wherein, for the purposes of establishing an electrically conductive connection between the voltage source and the electrical/electronic components, in each case electrically conductive contacts are provided on the housing parts, it being possible for contact to be established with these contacts via at least one plug-in connection, wherein at least one plug is provided on a housing part, and this plug interacts with a complementary socket on the other housing part, characterized in that the plug is arranged such that it allows electrically conductive contact to be established approximately perpendicularly to the longitudinal extent of the housing parts.

2. Control unit according to claim 1, characterized in that the plug is guided out of a housing part and, when the connection is being established, penetrates into a plug-in socket provided on the underside of the respectively other housing part, such that the plug-in connection is fully covered by the housing part.

3. Control unit according to claim 1, characterized in that the plug is designed as a right-angle plug.

4. Control unit according to claim 1, characterized in that the plug is designed as part of an end covering cap of a housing part.

5. Control unit according to claim 1, characterized in that the covering cap is designed as a strain-relief device at least for a cable connection from the control unit to a drive unit.

6. Control unit according to claim 4, characterized in that the covering cap has at least one lead-through for the plug of at least one cable connection.

7. Control unit according to claim 1, characterized in that the covering cap is designed in two parts, wherein a first and a second cap part secure at least one connecting cable between them with strain relief.

8. Control unit according to claim 1, characterized in that the housing parts are arranged on a carrying rail which, along with at least one housing part, forms a cable duct for at least one connecting cable.

9. Control unit according to claim 1, characterized in that the first and the second housing part can be locked to one another in a form-fitting manner in each case in the region of facing end sides.

10. Control unit according to claim 1, characterized in that the first and the second housing part can be latched to one another in a form-fitting manner in each case in the region of facing end sides.

11. Control unit according to claim 4, characterized in at least one covering cap forms part of a latching connection between the housing parts.

12. Control unit according to claim 7, characterized in that the plug is formed in one piece on the first cap part.

13. Control unit according to claim 8, characterized in that the first housing part, on its underside which faces the carrying rail, has at least one lead-through and/or plug-in socket for the plug of a cable connection.
